(19) United States
(12) Patent Application Publication
(10) Pub. No.: US 2026/0099007 A1
(43) Pub. Date: Apr. 9, 2026

(54) UNDERCUT-ASSISTED LONG RANGE EVANESCENT COUPLING BETWEEN WAVEGUIDES

(71) Applicant: Applied Materials, Inc., Santa Clara, CA (US)

(72) Inventors: Jinxin Fu, Santa Clara, CA (US); Zijiao Yang, Fremont, CA (US)

(21) Appl. No.: 19/331,580

(22) Filed: Sep. 17, 2025

Related U.S. Application Data
(60) Provisional application No. 63/704,104, filed on Oct. 7, 2024.

(51) Int. Cl. G02B 6/293; G02B 6/12; G02B 6/122; G02B 6/136; G02B 6/38

(52) U.S. Cl. CPC G02B 6/29331; G02B 6/12002; G02B 6/122; G02B 6/136; G02B 6/3801; G02B 2006/121; G02B 2006/12147; G02B 2006/12157; G02B 2006/12173; G02B 2006/12176

(57) ABSTRACT

An optical device includes a substrate, cladding material on the substrate, a first inner core within the cladding material, and a trench in the substrate that assists with evanescent coupling of an optical signal between the first inner core and a second inner core that is positioned farther from the substrate than the first inner core.

### CROSS-REFERENCE TO RELATED APPLICATION(S)

The present application claims the benefit of U.S. Patent Application No. 63/704,104, filed on Oct. 7, 2024, the entire contents of which are hereby incorporated by reference herein.

### TECHNICAL FIELD

Embodiments of the present disclosure relate to optical devices, and more particularly to undercut-assisted long range evanescent coupling between waveguides, such those included in optical interposers (“interposers”) and/or photonic integrated circuits (PICs) of co-packaged optical devices.

### BACKGROUND

In an optical system, an optical signal may travel through a waveguide (e.g., optical fiber) that is formed from an inner core made of a first material having a first index of refraction and an outer cladding structure made of a second material having a second index of refraction less than the first index of refraction. For example, the first material and the second material may each be formed from a different type of glass. The cladding structure helps to confine optical signals within the inner core by total internal reflection, reduce signal loss due to scattering and absorption, and provide protection for the inner core. Thus, when an optical signal traveling in a waveguide is incident on the boundary between the inner core and the cladding structure at an angle exceeding the critical angle, the optical signal may exhibit total internal reflection.

### SUMMARY

In some embodiments, an optical device includes a substrate, cladding material on the substrate, a first inner core within the cladding material, and a trench in the substrate that assists with evanescent coupling of an optical signal between the first inner core and a second inner core that is positioned farther from the substrate than the first inner core.

In some embodiments, an optical device includes an optical interposer. The optical interposer includes an interposer substrate, first cladding material on the interposer substrate, and a plurality of interposer inner cores within the first cladding material. The device further includes a photonic integrated circuit (PIC) coupled to the optical interposer. The PIC includes a PIC substrate, second cladding material on the PIC substrate, at least one PIC inner core within the second cladding material, and a trench in the interposer substrate that assists with evanescent coupling of an optical signal between the plurality of interposer inner cores and the at least one PIC inner core.

In some embodiments, a method includes forming a trench within a substrate and forming, from the substrate, a component of an optical device. The component includes
cladding material on the substrate that encloses the trench, and a first inner core within the cladding material. The trench assists with evanescent coupling of an optical signal between the first inner core and a second inner core that is positioned farther from the substrate than the first inner core.

Numerous other aspects and features are provided in accordance with these and other embodiments of the disclosure. Other features and aspects of embodiments of the disclosure will become more fully apparent from the following detailed description, the claims, and the accompanying drawings.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIGS. 1A-1B are diagrams of views of example systems that may implement optical devices with interlayer waveguide structures, according to some embodiments.

FIGS. 2-3B are diagrams of example optical devices implementing undercut-assisted long range evanescent coupling between waveguides, according to some embodiments.

FIGS. 4A-4E are diagrams illustrating the fabrication of an example optical device implementing undercut-assisted long range evanescent coupling between waveguides, according to some embodiments.

FIGS. 5A-5B are diagrams illustrating the formation of a trench within a substrate, according to some embodiments.

FIGS. 6-9 are flowcharts of example methods to implement optical devices with undercut-assisted long range evanescent coupling between waveguides, according to some embodiments.

### DETAILED DESCRIPTION

Embodiments of the present disclosure relate to undercut-assisted long range evanescent coupling between waveguides. A co-packaged device (e.g., multi-chip module) may include a package substrate having multiple PICs assembled closely together. More specifically, optical components may be integrated on substrates (e.g., silicon (Si) substrate) for fabricating large-scale PICs that co-exist with micro-electronic chips. With the use of an optical transceiver, a received optical signal may be converted to an electrical signal capable of being processed by an integrated circuit, or the processed electrical signal may be converted to an optical signal to be transmitted via an optical fiber.

Instead of ICs (e.g., microchips) that utilize electrons to process information, referred to as electronic ICs (EICs), a PIC utilizes photons (light particles) to process information. A PIC may include multiple photonic components connected to a single chip. Examples of components of a PIC include optical signal generators (e.g., lasers) to generate optical signals (e.g., light), waveguides to direct optical signals within the PIC (e.g., similar to wires used to direct electrons), modulators to modulate optical signals to encode information, and detectors to detect and decode the information from the optical signals. PICs may have various advantages over EICs. For example, PICs may offer high data rates due to the high-speed performance capabilities of the integrated photonic components such as the optical modulator and detector. As another example, photons within PICs may experience less signal loss as compared to electrons within EICs, which enables more energy-efficient operation.

A co-packaged device may include an optical interposer (“interposer”) disposed between a first component and a second component. For example, an interposer may be placed between a package substrate and a ball grid array. An interposer is an electrical interface that routes connections between sockets or connections between the first component and the second component. An interposer may be used to connect components that may not naturally connect to one another. Some interposers may include multiple conductive layers (e.g., metal layers), where pairs of conductive layers are connected by at least one conductive via (“via”). For example, a first conductive layer of a first metallization level and a second conductive layer of a second metallization level may be connected by at least one via. Some interposers may further include multiple waveguides integrated near the conductive layers.

The waveguides of an interposer may use evanescent wave coupling to transmit an optical signal received from an initial waveguide of the interposer to a final waveguide of the interposer. For example, the initial waveguide may be integrated near a bottom conductive layer of the interposer, and the final waveguide may be integrated near a top conductive layer of the interposer. Evanescent wave coupling generally refers to a (quantum) tunneling phenomenon in which an evanescent wave exiting a first medium excites a wave in an adjacent medium that is sufficiently close to the first medium. For example, in an optical communication system, evanescent wave coupling may occur when an evanescent wave generated within a waveguide excites an electromagnetic wave in an adjacent waveguide. Evanescent wave coupling may be accomplished when two waveguides are positioned close together such that the evanescent field generated by one of the waveguides reaches the other waveguide before any substantial decay of the evanescent wave is experienced. Generally, an evanescent wave is an oscillating wave (e.g., electromagnetic wave or acoustic wave) generated at a boundary between two media and exists only within a very short distance from the boundary. Evanescent waves may exit the waveguide, and their amplitude may decay exponentially as a function of distance from the boundary. Thus, evanescent waves are generally observable in the near field of the optical signal in close proximity to the boundary.

Waveguides have been widely adopted and optimized in optical device (e.g., PIC) applications. Waveguides used in optical devices may be formed from any suitable material. Examples of materials include silicon nitride (SiₓN_{y}) (or SiN), lithium niobate (LiNbO₃), gallium arsenide (GaAs), indium phosphide (InP), etc. For example, properties of waveguides such as low loss, transparency over wide spectrum, high optical power handling capacity, mode confinement, and complementary metal-oxide semiconductor (CMOS) foundry process compatibility may increase data rates and signal bandwidth for datacenters, driven by recent surge of artificial intelligence generated content (AIGC) model training and inference such as large language models (LLMs).

The top cladding of a waveguide in a PIC (i.e., the portion of the cladding material above the inner core of the waveguide) is typically larger than 5 micrometers (μm) because of a thick metal redistribution layer (RDL) formed on top of the waveguide. The bottom cladding (i.e., the portion of the cladding material below the inner core of the waveguide), on the other hand, is typically thinner than 3 μm. If the optical mode inside the waveguide expands to be too large, then the optical mode may leak into the substrate (e.g., Si substrate, which is a higher index material) and cause optical loss. In the context of optics and photonics, an optical mode refers to a specific electromagnetic field distribution or pattern of light that may propagate through a medium, such as an optical fiber, waveguide, or resonator. Optical modes are characterized by their spatial distribution, polarization, and phase. Usually, the electromagnetic field is strong in the high index core area (e.g., which may be SiN), and decays from the core to the cladding (e.g., which may be SiOₓ). Accordingly, slower decay rates correspond to larger optical modes. Evanescent coupling between waveguides with high efficiency may be difficult to achieve if the gap is larger than the thickness of the bottom cladding. This makes it difficult to implement an interposer, since evanescent coupling between the PIC and the interposer would occur over a large gap through the RDL of the PIC. Although a staircase waveguide structure may be formed within an interposer to enable evanescent coupling through the interposer, the film stack of the PIC may not be easily changed to accommodate a staircase waveguide structure as well.

Aspects and implementations described herein may address these and other drawbacks by implementing undercut-assisted long range evanescent coupling between waveguides. An optical device described herein may include a substrate having a trench formed therein to assist with long range evanescent coupling. In some embodiments, the optical device is an interposer. More specifically, the trench may enable larger mode expansion with reduced or eliminated light leakage into the substrate, which may support evanescent coupling between a waveguide in the optical device and a waveguide in the PIC with a larger distance separation. For example, a trench may be formed within the substrate if the distance between the substrate and a furthest inner core away from the substrate is less than or equal to about 5 μm. Large mode expansion refers to a technique used to increase the effective size of the optical mode, or “mode field diameter,” in a waveguide or optical fiber. This may be done to facilitate efficient coupling between components with mismatched mode sizes, such as between a small-mode waveguide and a larger-mode optical fiber, or between different sections of PICs.

In some embodiments, the interposer is bonded to a PIC using hybrid bonding to form a hybrid bonded optical device. Hybrid bonding refers to bonding of components that include both conductive material (e.g., metal) and dielectric material at the interfaces between the components. At least one of the interposer or the PIC of the hybrid bonded optical device may include a substrate having a trench formed therein. In some embodiments, both of the interposer and the PIC of the hybrid bonded optical device include a substrate having a trench formed therein. Optical signals may be transferred between the PIC and the interposer using evanescent coupling. Hybrid bonding may enable high speed (e.g., greater than or equal to 100 gigabits (Gbs)/channel) optical and electrical connectivity between the interposer and the PIC.

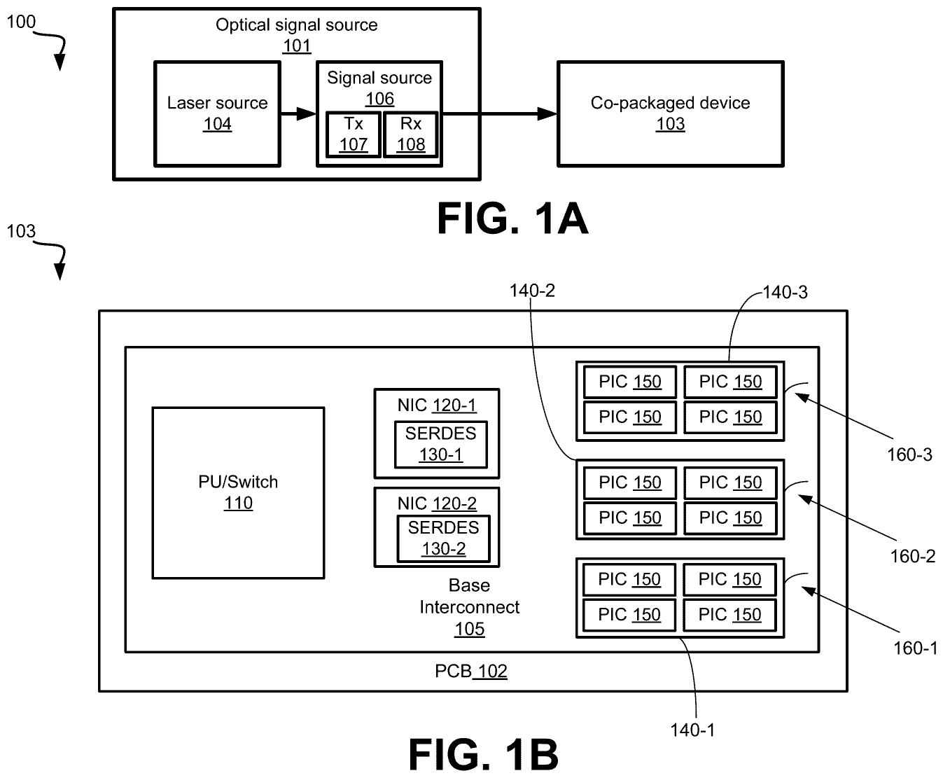

The index of refraction of the trench is air (e.g., 1). This is lower than the index of refraction of the material of the cladding material (e.g., silicon dioxide or SiO₂) and/or the index of refraction of the inner core formed within the cladding material. Optical modes tend to be pulled to materials having higher indices of refraction. Any leakage into the empty space of the trench will not cause optical loss because of the lower index of refraction, since light is still guided inside the inner core and cladding material. For example, the optical mode may be being pulled to the center of the two bonding dies of the hybrid bonded optical device. Further details regarding implementing undercut-assisted long range evanescent coupling between waveguides are described below with reference to FIGS. 1A-8.

Embodiments described herein may provide numerous other technical advantages. For example, embodiments described herein may improve evanescent coupling between waveguides of an optical device.

FIG. 1A is a block diagram of system 100, according to some embodiments. As shown, the system 100 may include optical signal source 101 and co-packaged device 103. Optical signal source 101 may include a laser source 104 that may output coherent light that lacks a signal and a signal source 106 that applies a signal to the light by modulating the light. For example, the signal source 106 may include a ring resonator in some embodiments. The signal source 106 may include, for example, a transmitter (Tx) and/or a receiver (Rx) in embodiments. Optical signal source 101 may provide, as input to co-packaged device, multiple wavelengths of optical signals (e.g., multiple wavelengths of light). An example of co-packaged device 103 will now be described below with reference to FIG. 1B.

FIG. 1B is a block diagram of a top-down view of co-packaged device 103, according to some embodiments. As shown in FIG. 1B, co-packaged device 103 may include printed circuit board (PCB) 102, base interposer (e.g., interposer) 105, at least one processing unit and/or switch (PU/switch) 110 formed on base interposer 105, at least one network interface card (NIC) 120-1, 120-2 formed on base interposer 105, multiple interposers 140-1 through 140-3 formed on base interposer 105, multiple photonic integrated circuits (PICs) 150 formed on each of interposers 140-1 through 140-3, and multiple waveguides 160-1 through 160-3 each coupled to a respective one of interposers 140-1 through 140-3. In embodiments, each of the NICs 120-1, 120-2 may include a serializer-deserializer (SERDES) 130-1, 130-2 formed on base interposer 105. In some embodiments, and as shown, the number of interposers is three. However, the number of interposers should not be considered limiting. In some embodiments, and as shown, each set of PICs 750s includes four PICs. However, the number of PICs should not be considered limiting. More specifically, each of interposers 140-1 through 140-3 may be disposed between respective sets of PICs 150 and base interposer 105.

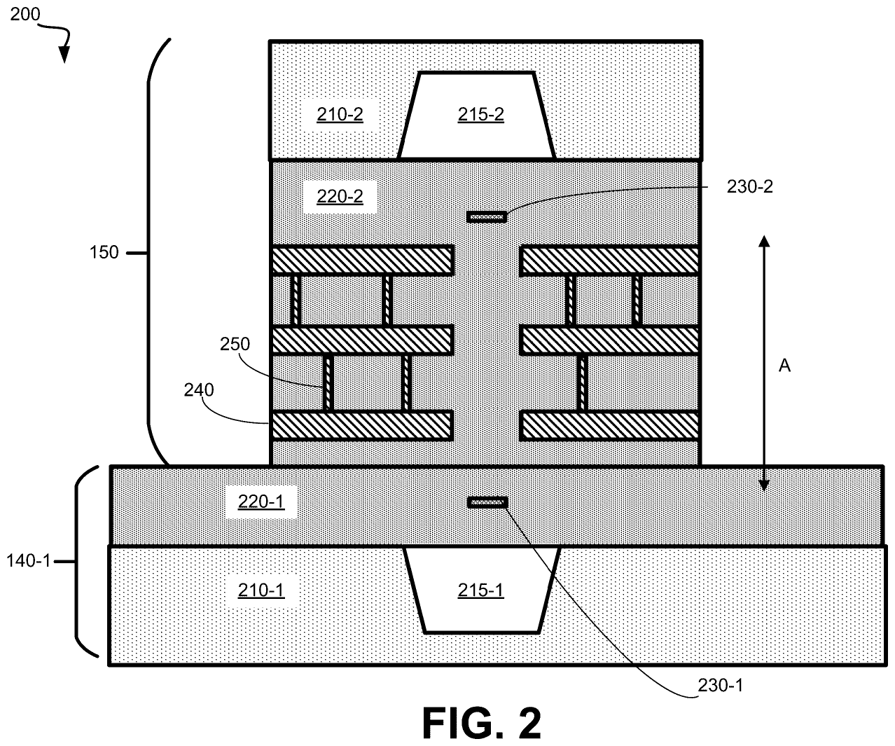

FIG. 2 is a cross-sectional view of an optical device (“device”) 200, according to some embodiments. As illustrated in FIG. 2, the device 200 includes an interposer 140-1 and a PIC 150 formed on top of the interposer 140-1. In some embodiments, the interposer 140-1 is hybrid bonded to the PIC 150, enabling both electrical and optical interconnections with high alignment precision and low interface loss.

The interposer 140-1 includes a substrate 210-1, which may be fabricated from any suitable material such as silicon (Si), silicon-germanium (SiGe), or glass, depending on the desired optical and mechanical properties. Formed atop the substrate 210-1 is a cladding material 220-1, which may be composed of an oxide material, such as silicon dioxide (SiO2), to provide optical isolation and mechanical support for embedded structures.

Within the cladding material 220-1, at least one inner core of waveguides, such as inner core 230-1, is formed. The inner core 230-1 may be fabricated from materials with high refractive index contrast relative to the cladding, such as silicon nitride (SiN), lithium niobate (LiNbO3), gallium arsenide (GaAs), or indium phosphide (InP), to support low-loss optical guidance and efficient coupling.

The PIC 150 similarly includes a substrate 210-2, which may be fabricated from the same or a different material as substrate 210-1 (e.g., Si, SiGe, or glass), depending on the integration requirements. A cladding material 220-2 is formed on the substrate 210-2, which may also be an oxide such as SiO2, providing optical confinement and electrical insulation. Within the cladding material 220-2, at least one inner core of a waveguide, such as inner core 230-2, is formed. The inner core 230-2 may be made from materials similar to those used for inner core 230-1 (e.g., SiN, LiNbO3, GaAs, InP), allowing for efficient optical transmission and compatibility with various photonic device architectures. In some embodiments, a distance “A” between the inner core 230-1 and the inner core 230-2 is less than or equal to about 5 μm.

The PIC 150 further includes a set of interconnect structures within the cladding material 220-2. The set of interconnect structures may include electrical components that enable vertical and lateral electrical connections for signal routing, power delivery, or ground return. For example, as shown in FIG. 2, the set of interconnect structures may include conductive lines (e.g., conductive line 240) and vias (e.g., via 250), which are typically formed from highly conductive materials such as copper (Cu), tungsten (W), aluminum (Al), silver (Ag), gold (Au), molybdenum (Mo), titanium (Ti), or tantalum (Ta). Specifically, In some embodiments, the interposer 140-1 further includes a set of interconnect structures within the cladding material 220-1 (not shown in FIG. 2).

As depicted, a trench 215-1 is formed in the substrate 210-1 of the interposer 140-1, and a trench 215-2 is formed in the substrate 210-2 of the PIC 150. The trench 215-1 may be positioned between conductive lines in a region where evanescent optical coupling is intended to occur, according to some embodiments. Specifically, trench 215-1 acts as an undercut within the interposer 140-1, reducing the effective refractive index beneath the waveguide core and thereby enhancing long-range evanescent coupling between the inner cores of the optical device. Similarly, trench 215-2 serves as an undercut within the PIC 150 to facilitate long-range evanescent coupling, which is critical for efficient optical power transfer between vertically stacked or closely spaced waveguides.

In some embodiments, the depths of trenches 215-1 and 215-2 are greater than 5 μm, measured from the respective interfaces between the substrate 210-1 or the substrate 210-2 and the cladding material 220-1 or the cladding material 220-2. Alternative embodiments may utilize trench depths greater than 3 μm, 4 μm, 6 μm, 7 μm, or 10 μm. The trench depth may range from about 3 μm to about 12 μm, depending on the desired optical coupling efficiency, the mode field diameter of the waveguides, and fabrication constraints such as etch selectivity and aspect ratio limitations. Deeper trenches generally provide stronger mode confinement and improved coupling, but may introduce mechanical fragility or process complexity.

The length of the trench 215-1 and the trench 215-2 2 may range from 50 μm to 1 mm, with typical values including about 100 μm to 500 μm, about 150 μm to 400 μm, or about 200 μm to 350 μm. The width of the trench 215-1 and the trench 215-2 may also vary, with possible values greater than 3 μm, 4 μm, 5 μm, 6 μm, 7 μm, or 10 μm, and in some embodiments, the width of the trenches 215-1 and 215-2 ranges from about 3 μm to about 12 μm. The specific dimensions of the trench 215-1 and the trench 215-2 may be selected based on the optical mode size, the required coupling strength, and the mechanical stability of the structure.

From a top view, each of the trenches 215-1 and 215-2 may be formed in an area that is free of metal lines to prevent electrical interference and to maintain the integrity of the optical mode. In certain embodiments, each trench is positioned directly beneath a waveguide spot size conversion area. The waveguide spot size conversion area is a region or structure within the optical waveguide system designed to modify or match the mode field diameter (MFD), or “spot size,” of the light propagating through different waveguides or between a waveguide and another optical component. The spot size refers to the cross-sectional area of the optical mode where the majority of the light's energy is concentrated. Proper alignment of the trench with the spot size conversion area is critical to maximize coupling efficiency and minimize optical losses at the interface between the interposer and the PIC.

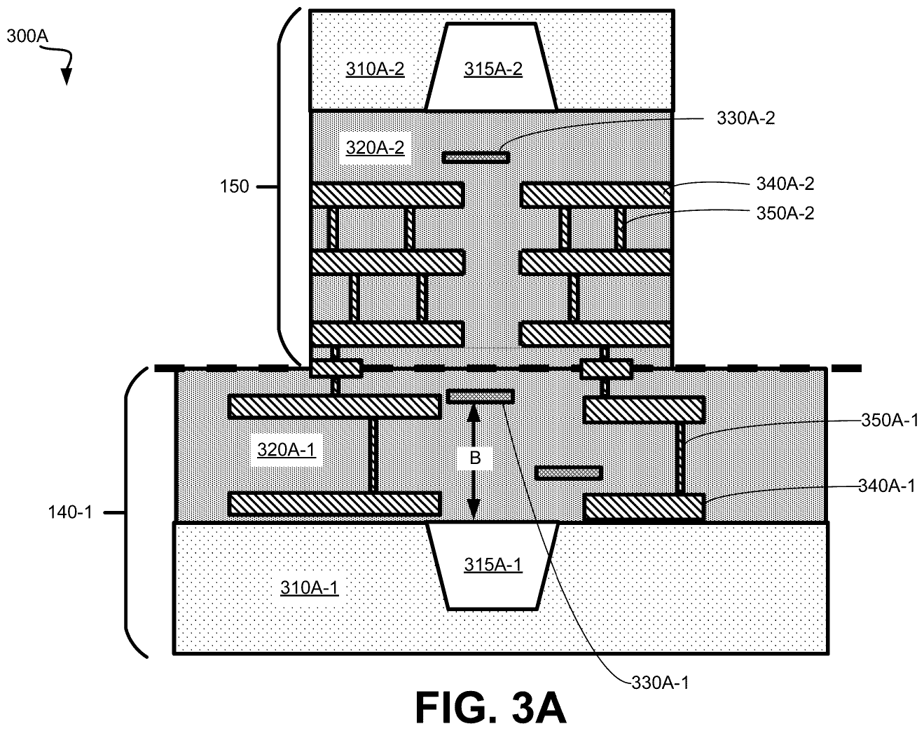

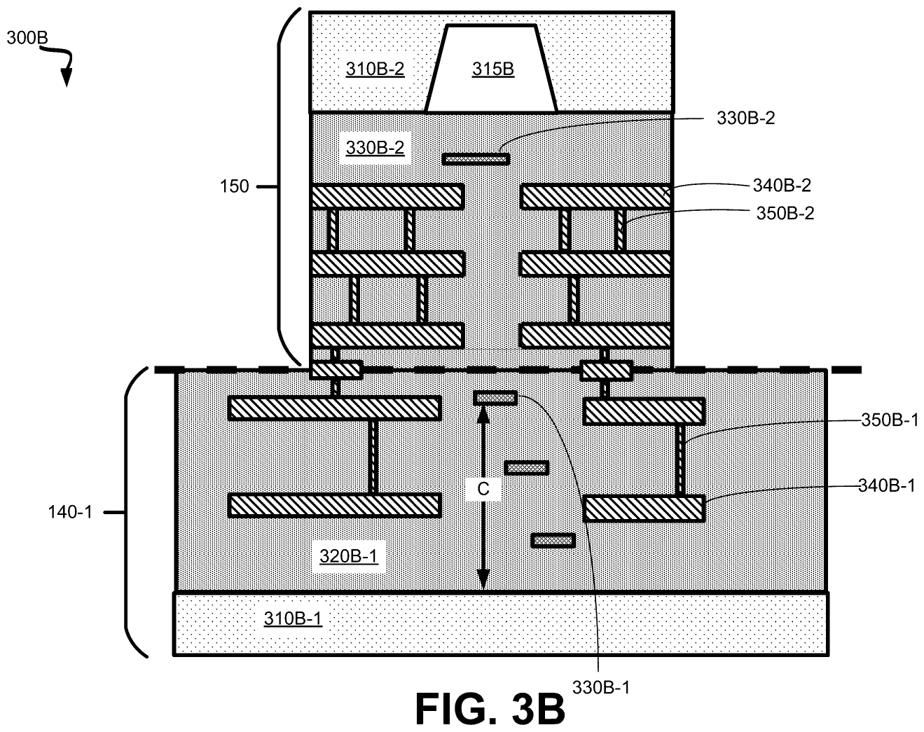

FIG. 3 is a cross-sectional view of an optical device (“device”) 300A, according to some embodiments. As illustrated in FIG. 2, the device 300A includes an interposer 140-1 and a PIC 150 formed on top of the interposer 140-1. In some embodiments, the interposer 140-1 is hybrid bonded to the PIC 150, enabling both electrical and optical interconnections with high alignment precision and low interface loss.

The interposer 140-1 includes a substrate 310A-1, which may be fabricated from any suitable material such as silicon (Si), silicon-germanium (SiGe), or glass, depending on the desired optical and mechanical properties. Formed atop the substrate 310A-1 is a cladding material 320A-1, which may be composed of an oxide material, such as silicon dioxide (SiO2), to provide optical isolation and mechanical support for embedded structures.

Within the cladding material 320A-1, a set of one or more inner cores of waveguides, including an inner core 330A-1, is formed. These inner cores may be arranged in configurations such as staircase or ladder waveguide structures to facilitate complex routing or mode conversion. The inner core 330A-1 may be fabricated from materials with high refractive index contrast relative to the cladding, such as silicon nitride (SiN), lithium niobate (LiNbO3), gallium arsenide (GaAs), or indium phosphide (InP), to support low-loss optical guidance and efficient coupling.

Additionally, the interposer 140-1 may incorporate a set of interconnect structures within the cladding material 320A-1. The set of interconnect structures may include electrical components that enable vertical and lateral electrical connections for signal routing, power delivery, or ground return. For example, the set of interconnect structures may include conductive lines (e.g., conductive line 340A-1) and vias (e.g., via 350A-1), which are typically formed from highly conductive materials such as Cu, W, Al, Ag, Au, Mo, Ti, or Ta.

The PIC 150 similarly includes a substrate 310A-2, which may be fabricated from the same or a different material as substrate 310A-1 (e.g., Si, SiGe, or glass), depending on the integration requirements. A cladding material 320A-2 is formed on the substrate 310A-2, which may also be an oxide such as SiO2, providing optical confinement and electrical insulation. Within the cladding material 320A-2, at least one inner core of a waveguide, such as inner core 330A-2, is formed. The inner core 330A-2 may be made from materials similar to those used for inner core 330A-1 (e.g., SiN, LiNbO3, GaAs, InP), allowing for efficient optical transmission and compatibility with various photonic device architectures.

The PIC 150 further includes a set of interconnect structures within the cladding material 320A-2, including conductive lines (e.g., conductive line 340A-2) and vias (e.g., 350A-2). These interconnects may be fabricated from the same or different conductive materials as those used in the interposer 140-1, providing flexibility in electrical design and integration.

As depicted, a trench 315A-1 is formed in the substrate 310A-1 of the interposer 140-1, and a trench 315A-2 is formed in the substrate 310A-2 of the PIC 150. The trench 315A-1 may be positioned between conductive lines in a region where evanescent optical coupling is intended to occur, according to some embodiments. Specifically, the trench 315A-1 acts as an undercut within the interposer 140-1, reducing the effective refractive index beneath the waveguide core and thereby enhancing long-range evanescent coupling between the inner cores of the optical device. Similarly, the trench 315A-2 serves as an undercut within the PIC 150 to facilitate long-range evanescent coupling, which is critical for efficient optical power transfer between vertically stacked or closely spaced waveguides.

In some embodiments, the depths of trench 315A-1 and the trench 315-2 are greater than 5 μm, measured from the respective interfaces between the substate 310A-1 or the substrate 310A-2 and the cladding material 320A-1 or the cladding material 320A-2). Alternative embodiments may utilize trench depths greater than 3 μm, 4 μm, 6 μm, 7 μm, or 10 μm. The trench depth may range from about 3 μm to about 12 μm, depending on the desired optical coupling efficiency, the mode field diameter of the waveguides, and fabrication constraints such as etch selectivity and aspect ratio limitations. Deeper trenches generally provide stronger mode confinement and improved coupling, but may introduce mechanical fragility or process complexity.

The length of the trench 315A-1 and the trench 315A-2 may range from 50 μm to 1 mm, with typical values including about 100 μm to 500 μm, about 150 μm to 400 μm, or about 200 μm to 350 μm. The width of the trench 315A-1 and the trench 315A-2 may also vary, with possible values greater than 3 μm, 4 μm, 5 μm, 6 μm, 7 μm, or 10 μm, and in some embodiments, the width of the trench 315A-1 and the trench 315A-2 ranges from about 3 μm to about 12 μm. The specific dimensions of the trench 315A-1 and the trench 315A-2 may be selected based on the optical mode size, the required coupling strength, and the mechanical stability of the structure.

From a top view, each of the trench 315A-1 and the trench 315A-2 may be formed in an area that is free of metal lines to prevent electrical interference and to maintain the integrity of the optical mode. In certain embodiments, each trench is positioned directly beneath a waveguide spot size conversion area. The waveguide spot size conversion area is a region or structure within the optical waveguide system designed to modify or match the mode field diameter (MFD), or “spot size,” of the light propagating through different waveguides or between a waveguide and another optical component. The spot size refers to the cross-sectional area of the optical mode where the majority of the light's energy is concentrated. Proper alignment of the trench with the spot size conversion area is critical to maximize coupling efficiency and minimize optical losses at the interface between the interposer and the PIC.

In some embodiments, a distance “B” between the inner core 330a-1 and the substrate 310A-1 is less than or equal to about 5 μm. In some embodiments, and as shown in FIG. 3B, a trench is not formed in the substrate 310A-1. For example, a trench is not formed in the substrate 310A-1 if the distance “B” is greater than about 5 μm, greater than 3 μm, greater than 4 μm, or greater than 6 μm in some embodiments.

FIG. 3B is a cross-sectional view of an optical device (“device”) 300B, according to some embodiments. As shown in FIG. 3, the device 300 includes an interposer 140-1 and a photonic integrated circuit (PIC) 150 formed on the interposer 140-1. In some embodiments, the interposer 140-1 is hybrid bonded to the PIC 150.

The interposer 140-1 includes a substrate 310B-1, which may be fabricated from any suitable material, such as Si, SiGe, or glass, depending on the desired electrical, thermal, and mechanical properties. On top of the substrate 310B-1, a cladding material 320B-1 is formed, which serves as an optical isolation layer and may be made from materials such as SiO2 or other oxides. The cladding material 320B-1 provides a low refractive index environment for the waveguide cores, minimizing optical loss and crosstalk.

Embedded within the cladding material 320B-1 is a set of inner cores for waveguides, including an inner core 330B-1. These inner cores may be arranged in a staircase or ladder configuration to facilitate complex routing and coupling schemes. The inner core 330B-1 may be fabricated from materials with high refractive indices suitable for guiding light, such as SiN, LiNbO₃, GaAs, or InP. The choice of material may depend on the target wavelength range and desired optical properties.

Additionally, the interposer 140-1 may incorporate a set of interconnect structures within the cladding material 320B-1. The set of interconnect structures may include electrical components that enable vertical and lateral electrical connections for signal routing, power delivery, or ground return. For example, the set of interconnect structures may include conductive lines (e.g., conductive line 340B-1) and vias (e.g., via 350B-1), which are typically formed from highly conductive materials such as Cu, W, Al, Ag, Au, Mo, Ti, or Ta.

The PIC 150 similarly comprises a substrate 310B-2, which may be made from the same material as substrate 310B-1 or a different material, such as Si, SiGe, or glass, to optimize performance for specific applications. A cladding material 320B-2 is formed on substrate 310B-2, which may be composed of the same or different material as cladding material 320B-1, such as SiO2 or other suitable oxides. This layer provides optical isolation and supports the formation of waveguide structures.

Within the cladding material 320B-2, at least one inner core of a waveguide, such as inner core 330B-2, is formed. The inner core 330B-2 may be fabricated from materials similar to those used for inner core 330B-1, including SiN, LiNbO3, GaAs, or InP, chosen for their optical properties and compatibility with the overall device architecture. The PIC 150 also includes a set of interconnect structures within the cladding material 320B-2, such as conductive line 340B-2 and via 350B-2. Each interconnect structure typically includes a via coupled to a conductive line, for example, via 340B-2 connected to conductive line 350B-2. These structures may be made from any suitable conductive material, including those listed above, and may be the same or different from the materials used in the interposer 140-1, depending on design requirements.

As shown in FIG. 3, a trench 315B is formed in the substrate 310B-2 of the PIC 150, while no trench is present in the substrate 310B-1 of the interposer. The trench 315B creates an undercut region beneath the waveguide core in the PIC 150, which is engineered to enhance long-range evanescent coupling between waveguides in the PIC and those in the interposer. This undercut reduces the effective refractive index beneath the waveguide, increasing the evanescent field overlap and enabling efficient optical power transfer across the interface. In some embodiments, a distance “C” between the inner core 330B-1 and the substrate 310B-1 is greater than about 5 μm, which further reduces substrate-induced optical loss and improves coupling efficiency.

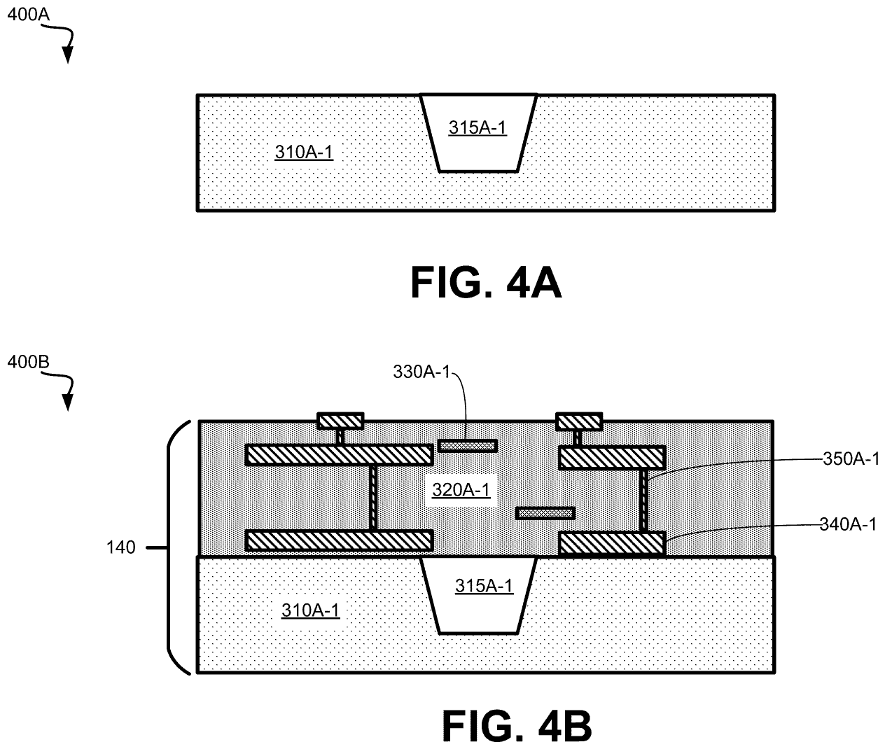

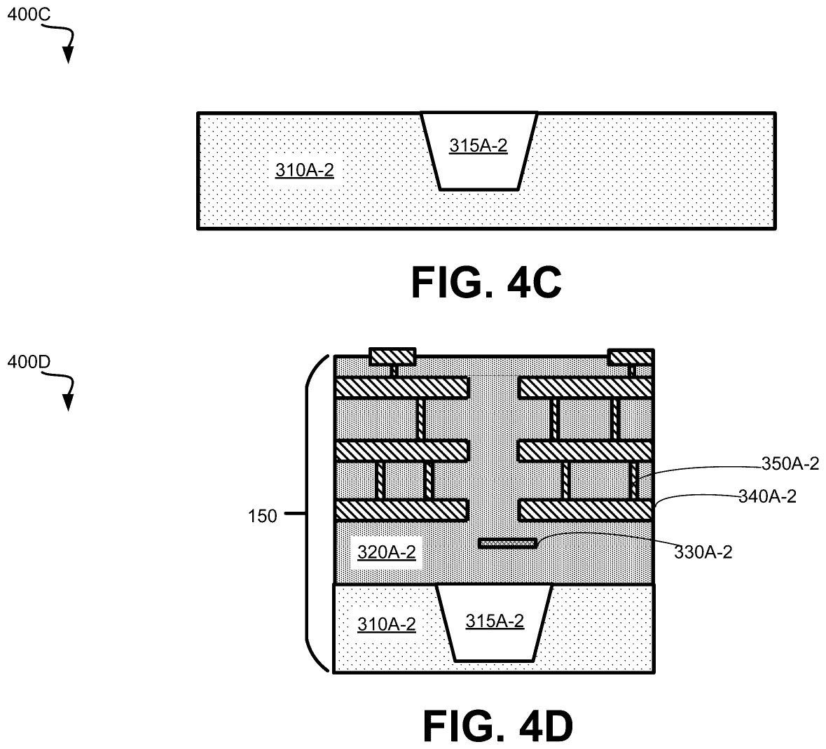

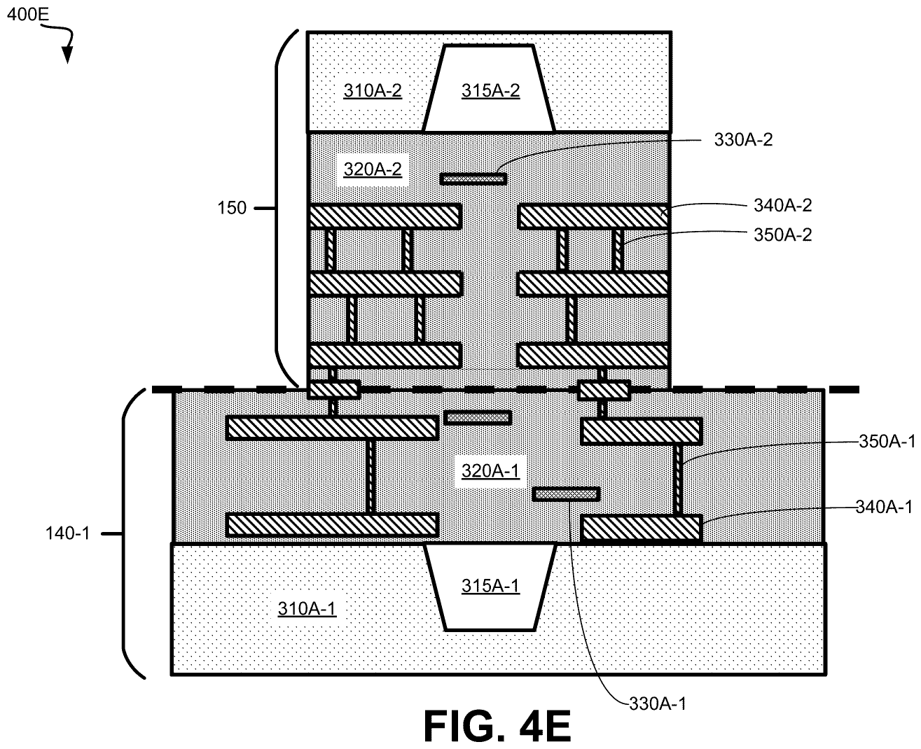

This architecture allows for high-density integration of photonic and electronic components, supporting advanced functionalities such as wavelength multiplexing, signal routing, and hybrid integration of active and passive devices. Further details regarding fabricating the device 200, the device 300A and the device 300B will now be described below with reference to FIGS. 4A-8.

FIGS. 4A-4E are diagrams illustrating the fabrication of an example optical device implementing undercut-assisted long range evanescent coupling between waveguides, according to some embodiments. For example, FIGS. 4A-4E may illustrate the fabrication of the device 200 of FIG. 2. However, a similar process may be used to fabricate the device 300 of FIG. 3.

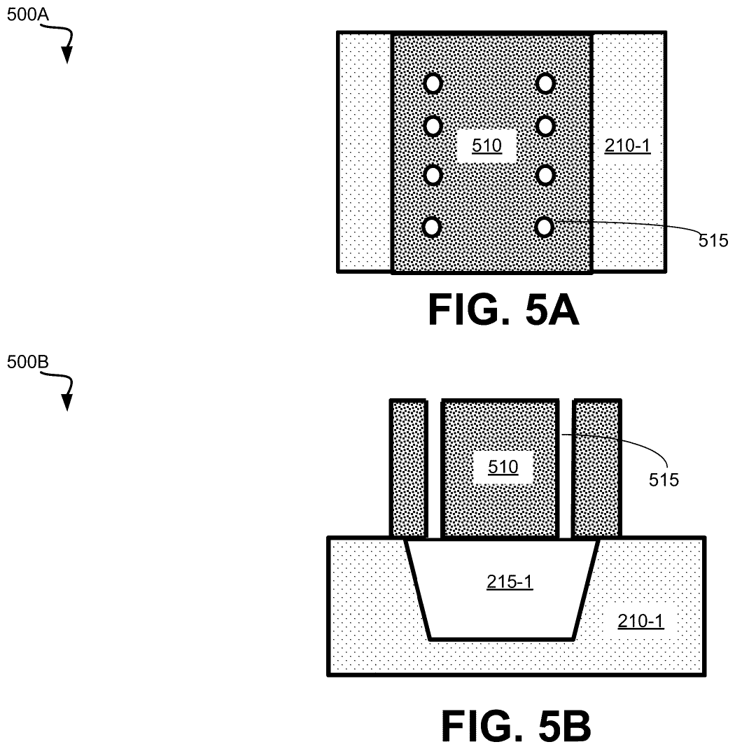

For example, FIG. 4A is a diagram 400A showing the formation of the trench 315A-1 within the substrate 310A-1. In some embodiments, and as will be described below with reference to FIGS. 5A-5B, forming the trench 315A-1 within the substrate 310A-1 may include forming a mask on the substrate 310A-1, forming a plurality of holes within the mask, and performing a wet etch process using the mask.

FIG. 4B is a diagram 400B showing the formation of the cladding material 320A-1 on the substrate 310A-1, the set of inner cores including inner core 330A-1 within the cladding material 320A-1, and the set of interconnect structures including the conductive line 340A-1 and the via 350A-1 within the cladding material 320A-1.

For example, forming the cladding material 320A-1 and the set of inner cores may include forming a first portion of the cladding material 320A-1 on the substrate 310A-1 (e.g., depositing and planarizing a first dielectric layer), forming a first layer of inner core material on the first portion of the cladding material 320A-1 (e.g., depositing and planarizing the first layer of inner core material), patterning the first layer of inner core material to form a first inner core, forming a second portion of the cladding material 320A-1 (e.g., depositing and planarizing a second dielectric layer), forming a second layer of inner core material on the second portion of the cladding material 320A-1 (e.g., depositing and planarizing the second layer of inner core material), patterning the second layer of inner core material to form a second inner core (inner core 330A-1), and forming a third portion of the cladding material 320A-1 (e.g., depositing and planarizing a third dielectric layer).

FIG. 4C is a diagram 400C showing the formation of the trench 315A-2 within the substrate 310A-2. In some embodiments, and as will be described below with reference to FIGS. 5A-5B, forming the trench 315A-2 within the substrate 310A-2 may include forming a mask on the substrate 310A-2, forming a plurality of holes within the mask, and performing a wet etch process using the mask.

FIG. 4D is a diagram 400C showing the formation of the cladding material 320A-2 on the substrate 310A-2, the set of inner cores including inner core 330A-2 within the cladding material 320A-2, and the set of interconnect structures including the conductive line 340A-2 and the via 350A-2 within the cladding material 320A-2. The cladding material 320A-1, the set of inner cores, and the set of interconnect structures may be formed using a similar process as described above with reference to FIG. 4B.

FIG. 4E is a diagram 400E showing the hybrid bonding of the interposer 140-1 and the PIC 150 to form an optical device. Further details regarding FIGS. 4A-4E are described above with reference to FIGS. 2-3 and will now be described below with reference to FIGS. 5A-8.

FIG. 5A is a diagram 500A of a top-down view illustrating the formation of a trench within a substrate, and FIG. 5B is a diagram 500B of a cross-sectional view illustrating the formation of the trench within the substrate. In these examples, the substrate is the substrate 210-1 of FIG. 2 and the trench is the trench 215-1 of FIG. 2. However, a similar process may be used to form any of the trenches described herein. As shown in FIGS. 5A-5B, a mask 510 is formed on the substrate. Then a set of holes, including hole 515, is formed within the mask 510. In some embodiments, the set of holes is drilled into the mask 510. Then, a wet etchant selected to etch the material of the substrate 210-1 may be introduced within the set of holes. In some embodiments, the wet etchant (which may be used to form the undercut in the Si) is potassium hydroxide (KOH). Other etchants may also be used. The spacing of the set of holes may create the trench 215-1 to have a suitable geometry to assist long range evanescent coupling between waveguides. In embodiments, the holes may have a diameter and/or depth of about 100 nm to about 5 μm (e.g., 150 nm to 4 μm, 200 nm to 3 μm, 400 nm to 2 μm, 500 nm to 1 micron, etc.). In some embodiments, the mask 510 is formed from SiO₂.

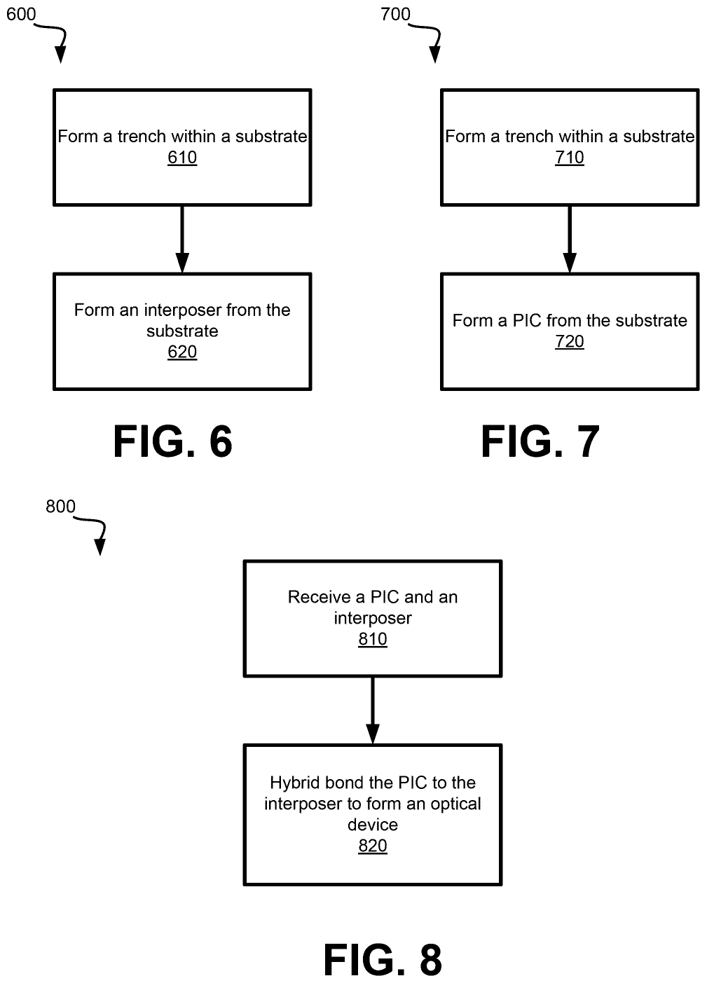

FIG. 6 is a flowchart of a method 600 to fabricate an optical device with undercut-assisted long range evanescent coupling between waveguides, according to some embodiments. For example, the method 600 may be used to fabricate one or more of optical devices 200A-300 described above with reference to FIGS. 2-4E.

At block 610, a trench is formed within a substrate. For example, as described above with reference to FIGS. 5A-5B, forming the trench may include forming a mask on the substrate, forming a set of holes within the mask, and introducing a wet etchant within the set of holes.

At block 620, an interposer is formed from the substrate. The interposer may be a component of co-packaged optical device. For example, forming the interposer may include forming, on the substrate, a set of inner cores within a cladding material, and forming a set of interconnect structures within the cladding material. In some embodiments, forming the interposer includes depositing an SiOₓ bottom cladding, subsequently depositing an SiN layer, performing lithography to pattern the SiN layer, etching the patterned SiN layer to form an SiN waveguide, depositing an SiOₓ top cladding, performing chemical mechanical planarization (CMP) to polish the SiOₓ top cladding, performing lithography to pattern the SiOₓ top cladding, performing etch to form SiOₓ holes to reach the Si substrate, and then performing a wet etch of the exposed region of the Si substrate to form an undercut therein. In some embodiments, the distance between the substrate and an inner core farthest from the substrate within the interposer is less than or equal to 5 μm. Further details regarding blocks 610-620 are described above with reference to FIGS. 2-5B.

FIG. 7 is a flowchart of a method 700 to fabricate an optical device with undercut-assisted long range evanescent coupling between waveguides, according to some embodiments. For example, the method 700 may be used to fabricate one or more of optical devices 200A-300 described above with reference to FIGS. 2-4E.

At block 710, a trench is formed within a substrate. For example, forming the trench may include forming a mask on the substrate, forming a set of holes within the mask, and introducing a wet etchant within the set of holes.

At block 720, a PIC is formed from the substrate. The PIC may be a component of co-packaged optical device. For example, forming the PIC may include forming, on the substrate, a set of inner cores within a cladding material, and forming a set of interconnect structures within the cladding material. Further details regarding blocks 710-720 are described above with reference to FIGS. 2-5B.

FIG. 8 is a flowchart of a method 800 to fabricate a hybrid bonded optical device, according to some embodiments. At block 810, a PIC and an interposer are received and, at block 820, the PIC is hybrid bonded to the interposer to form an optical device. The bonding process may be performed to bond SiOₓ interfaces of the interposer and the PIC. In one embodiment, performing the bonding process includes performing CMP to polish a surface of the PIC and/or a surface of the interposer, cleaning the PIC and/or interposer, performing surface activation of the PIC and/or interposer, placing the PIC chip onto the interposer with accurate alignment, and performing annealing to convert a Van Der Walls bond between the PIC and interposer to a covalent bond. Surface activation refers to the process of modifying the surface of a material, such as an interposer or an optical device, to enhance its chemical or physical properties, improving its ability to bond with other materials, adhere to coatings, or interact with its environment. Surface activation may be performed via plasma treatment, UV and/or ozone treatment, chemical treatment, thermal activation, and/or ion beam treatment in embodiments.

For example, the hybrid bonded optical device may be similar to the optical device 200 described above with reference to FIG. 2 or the optical device 300 described above with reference to FIG. 3. In some embodiments, receiving the PIC and the interposer includes forming at least one of the PIC or the interposer. Further details regarding blocks 810-820 are described above with reference to FIGS. 2-7.

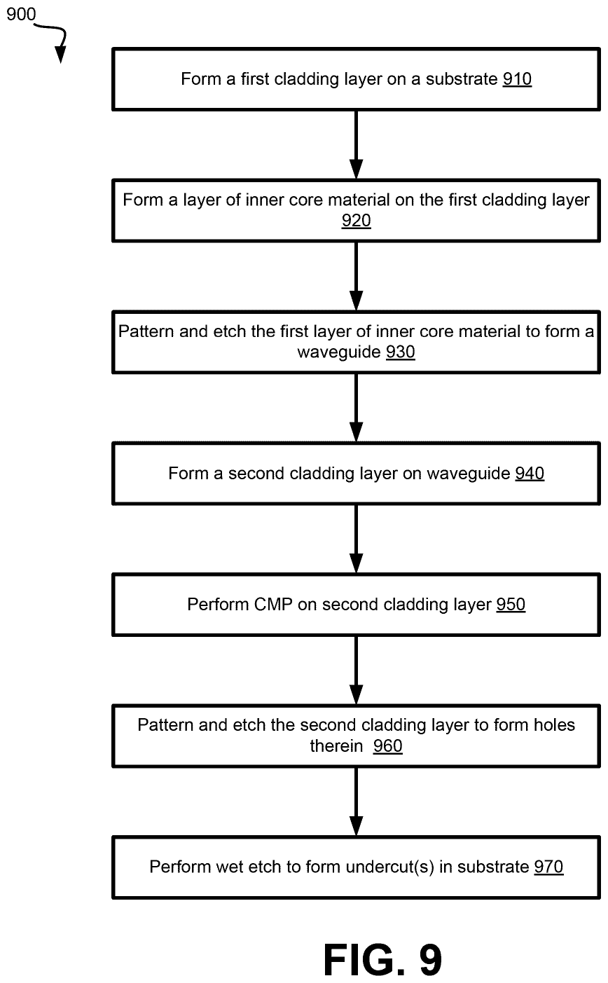

FIG. 9 is a flowchart of a method 900 to fabricate a device, according to some embodiments. For example, the method 900 may be used to fabricate an interposer (e.g., the method 600 of FIG. 6) and/or a PIC (e.g., the method 700 of FIG. 7). At block 910, a first cladding material is formed on a substrate. The first cladding material may be formed by depositing an SiO layer that acts as a bottom cladding in embodiments. At block 920, a layer of inner core material (e.g., an SiN layer) is formed on the first cladding material. At block 930, the layer of inner core material is patterned using photolithography and is then etched to form an inner core, which may be an SiN waveguide. At block 940, a second cladding material is formed on the inner core (e.g., on the SiN waveguide). The second cladding material may be a top cladding material (e.g., formed of SiOₓ) in embodiments.

At block 950, CMP is performed to polish a surface of the second cladding material. At block 960, the second cladding material is pattered using lithography and is subsequently etched to form holes in the second cladding material (e.g., to form SiOₓ holes). The holes in the second cladding material may extend to the underlying substrate in embodiments. For example, the holes in the second cladding material may extend through the inner core material and/or the first cladding material in embodiments. At block 970, an etch (e.g., a wet etch) may be performed on exposed regions of the substrate that are exposed by the formed holes. The wet etch may be performed using etchants that etch silicon, such as potassium hydroxide (KOH), tetramethylammonium hydroxide (TMAH), hydrofluoric acid (HF), nitric acid (HNO3) mixed with hydrofluoric acid (HF), ethylene diamine pyrocatechol (EDP), and so on. Once the device (e.g., PIC and/or interposer) that includes the undercut(s) is manufactured, it may be bonded to another device (e.g., interposer and/or PIC) as described above.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

As used herein, the singular forms “a,” “an,” and “the” include plural references unless the context clearly indicates otherwise. Thus, for example, reference to “a precursor” includes a single precursor as well as a mixture of two or more precursors; and reference to a “reactant” includes a single reactant as well as a mixture of two or more reactants, and the like.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%, such that “about 10” would include from 9 to 11.

The term “at least about” in connection with a measured quantity refers to the normal variations in the measured quantity, as expected by one of ordinary skill in the art in making the measurement and exercising a level of care commensurate with the objective of measurement and precisions of the measuring equipment and any quantities higher than that. In certain embodiments, the term “at least about” includes the recited number minus 10% and any quantity that is higher such that “at least about 10” would include 9 and anything greater than 9. This term may also be expressed as “about 10 or more.” Similarly, the term “less than about” typically includes the recited number plus 10% and any quantity that is lower such that “less than about 10” would include 11 and anything less than 11. This term may also be expressed as “about 10 or less.”

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. An optical device comprising:
a substrate;
cladding material on the substrate;
a first inner core within the cladding material; and
a trench in the substrate that assists with evanescent coupling of an optical signal between the first inner core and a second inner core that is positioned farther from the substrate than the first inner core.

2. The optical device of claim 1, wherein:
the trench has a depth that ranges from about 3 micrometers to about 12 micrometers;
the trench has a length that ranges between about 50 micrometers to about 1 millimeter; and
the trench has a width that ranges from about 3 micrometers to about 12 micrometers.

3. The optical device of claim 1, wherein the trench is aligned with a spot size conversion area associated with the first inner core.

4. The optical device of claim 1, further comprising interconnect structures within the cladding material.

5. The optical device of claim 1, wherein the substrate, the cladding material, and the first inner core are comprised within an optical interposer of the optical device.

6. The optical device of claim 5, wherein:
the first inner core corresponds to an initial inner core of a plurality of inner cores within the cladding material;
the second inner core corresponds to a final inner core of a plurality of inner cores within the cladding material; and
the substrate and the final inner core are separated by a distance of less than or equal to about 5 micrometers.

7. The optical device of claim 5, wherein the second inner core is comprised within a photonic integrated circuit (PIC) of the optical device, and wherein the PIC is coupled to the optical interposer.

8. The optical device of claim 1, wherein the substrate, the cladding material, and the first inner core are comprised within a photonic integrated circuit (PIC) of the optical device.

9. The optical device of claim 8, wherein the second inner core is comprised within an optical interposer of the optical device, and wherein the PIC is coupled to the optical interposer.

10. An optical device comprising:
an optical interposer comprising an interposer substrate, first cladding material on the interposer substrate, and a plurality of interposer inner cores within the first cladding material; and
a photonic integrated circuit (PIC), coupled to the optical interposer, comprising a PIC substrate, second cladding material on the PIC substrate, at least one PIC inner core within the second cladding material, and a trench in the interposer substrate that assists with evanescent coupling of an optical signal between the plurality of interposer inner cores and the at least one PIC inner core.

11. The optical device of claim 10, wherein:
the trench has a depth that ranges from about 3 micrometers to about 12 micrometers;
the trench has a length that ranges between about 50 micrometers to about 1 millimeter; and
the trench has a width that ranges from about 3 micrometers to about 12 micrometers.

12. The optical device of claim 10, wherein the trench is aligned with a spot size conversion area associated with the at least one PIC inner core.

13. The optical device of claim 10, wherein the optical interposer further comprises a second trench that assists with the evanescent coupling of the optical signal between the plurality of interposer inner cores and the at least one PIC inner core.

14. The optical device of claim 13, wherein the plurality of interposer inner cores comprises an initial inner core located closest to the interposer substrate and a final inner core located farthest from the substrate, and wherein the interposer substrate and the final inner core are separated by a distance of less than or equal to about 5 micrometers.

15. The optical device of claim 13, wherein:
the second trench has a depth that ranges from about 3 micrometers to about 12 micrometers;
the second trench has a length that ranges between about 50 micrometers to about 1 millimeter; and
the second trench has a width that ranges from about 3 micrometers to about 12 micrometers.

16. The optical device of claim 13, wherein the second trench is aligned with a spot size conversion area associated with the plurality of interposer inner cores.

17. The optical device of claim 10, further comprising interconnect structures within the first cladding material and the second cladding material.

18. The optical device of claim 10, wherein the PIC is hybrid bonded to the optical interposer.

19. A method comprising:
forming a trench within a substrate; and
forming, from the substrate, a component of an optical device, the component comprising:
cladding material on the substrate that encloses the trench; and
a first inner core within the cladding material, wherein the trench assists with evanescent coupling of an optical signal between the first inner core and a second inner core that is positioned farther from the substrate than the first inner core.

20. The method of claim 19, wherein forming the component from the substrate comprises:
forming a first portion of the cladding material on the substrate;
forming a first layer of inner core material on the first portion of the cladding material;
patterning the first layer of inner core material to form a first inner core;
forming a second portion of the cladding material on the first inner core;
forming a second layer of inner core material on the second portion of the cladding material;
patterning the second layer of inner core material to form a second inner core; and
forming a third portion of the cladding material on the second inner core.
